(19) United States
(12) Patent Application Publication
(10) Pub. No.: US 2022/0340707 A1
(43) Pub. Date: Oct. 27, 2022

(54) Bifuran copolyesters and a method for preparation thereof

(71) Applicant: OULUN YLIOPISTO, Oulun ylipisto (FI)

(72) Inventors: Juha Heiskanen, Oulu (FI); Tuomo Kainulainen, Oulu (FI)

(21) Appl. No.: 17/620,787

(22) PCT Filed: Jun. 20, 2019
(86) PCT No.: PCT/FI2019/050487

§ 371 Date: Dec. 20, 2021

(51) Int. Cl. C08G 63/185

(52) U.S. Cl. CPC C08G 63/185

(57) ABSTRACT

The present invention is directed to bifuran copolyesters comprising 2,2′-bifuran-5,5′-dicarboxylic monomer residues. The present invention is further directed to films, coatings or articles comprising said bifuran copolyesters. Also production methods for said bifuran copolyesters are provided. The invention is also directed to a use of a 2,2′-bifuran-5,5′-dicarboxylic monomers in preparing copolyesters having ultraviolet light (UV) blocking properties.

### FIELD OF THE INVENTION

The present invention relates generally to polymer chemistry and particularly to the synthesis of a novel bifuran copolyester. In certain aspects, the invention also relates to food and beverage packaging materials.

### BACKGROUND OF THE INVENTION

Recently, there has been an increased focus on obtaining polymeric materials derived from renewable resources. This growing trend is aiming at finding replacements to fossil-based resources and materials such as poly(ethylene terephthalate), PET, a high performance plastic that is especially prevalent in packaging due to its gas barrier properties, transparency, and mechanical strength.

Biomass offers a promising renewable alternative to fossil resources, as production of chemicals and materials can be achieved in a carbon-neutral way. In particular, furans are bio-based platform-chemicals, which are easily prepared from plant-based biomasses. Moreover, furans have long been studied as potential precursors for various types of polymers such as thermosets and thermoplastics. More recently, polyesters have become a particularly prominent area of research.

As simple dehydration products of monosaccharides, furans are key bio-based aromatic chemicals with various uses. Moreover, furan-based polyesters, in particular poly(ethylene furanoate) (PEF), possess advantageous material properties. PEF is known to have low oxygen and carbon dioxide permeability, even when compared to PET, a well-known packaging polyester. Reduced permeability to various gases can lead to higher performance packaging.

2,2′-Bifuran-5,5′-dicarboxylic acid (BFDCA) has recently been described as another furan-based precursor for novel bio-based polyesters (Kainulainen et al., 2018, Miyagawa et al, 2018). As a furan “dimer”, BFDCA consists fully of bio-based carbon. It has been shown that BFDCA-based homopolyesters, e.g. poly(ethylene bifuranoate) (PEBf), have relatively high glass-transition temperatures, and that the highly conjugated molecular structure of the bifuran monomer provides inherent ultraviolet (UV) light absorption. In addition, it was shown that PEBf possesses lower O₂ and water vapor permeability than PET. In the present invention, the synthesis of new random copolyesters comprising BFDCA structures is presented. Thermal and mechanical properties of the copolyesters are then compared to the pure homopolyesters.

### SUMMARY OF THE INVENTION

The present invention is based on a discovery that, surprisingly, the UV light absorption property provided by BFDCA structures for the homopolyester retains in a mixed copolyester even in the case when the copolymer comprises a relatively low number of BFDCA structures. UV-protecting plastics or coatings are useful in food packages and, e.g., in photovoltaic cells, as organic solar cells can retain more of their efficiency over time when properly protected from UV radiation. Further, the novel copolyesters are also promising oxygen and water barrier materials.

Accordingly, in several embodiments, the present invention provides a copolyester comprising repeating units of (i) a 2,2′-bifuran-5,5′-dicarboxylic monomer residue, (ii) a diol monomer residue and (iii) an aliphatic or cycloaliphatic C₃-C₈ dicarboxylic monomer residue or an aromatic C₆-C₈ dicarboxylic monomer residue.

In certain aspects, the present invention provides a film or coating comprising or consisting of said copolyester.

In certain aspects, the present invention provides an article or packaging material comprising or consisting of said copolyester, preferably for use in food or beverage packaging.

In other related aspects, the present invention provides a method of preparing a bifuran copolyester, the method comprising the steps of:

a) combining at least (i) a bifuran of Formula

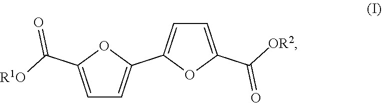

wherein R¹ and R² are each independently selected from the group consisting of: —H, —CH₃, —CH₂CH₃, —(CH₂)₂CH₃, —CH(CH₃)₂, —(CH₂)₃CH₃, —(CH₂)₂OH, —(CH₂)₃OH, —(CH₂)₄OH, —(CH₂)₅OH, —(CH₂)₆OH, —(CH₂)₇OH, —(CH₂)₈OH, and

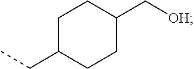

(ii) a diester of an aliphatic or cycloaliphatic C₃-C₈ dicarboxylic monomer residue or of an aromatic C₆-C₈ dicarboxylic monomer residue;

(iii) an aliphatic, cycloaliphatic or aromatic C₁-C₈ diol and (iv) a metal catalyst to form a reaction mixture;

b) subjecting the mixture combined in step a) to a temperature in the range of from about 140° C. to about 220° C. under an inert atmosphere; and

c) performing polycondensation to the mixture obtained in step b) by heating under reduced pressure to a temperature in the range of from about 210° C. to about 260° C.

In a further aspect, the present invention is directed to a use of a diester of 2,2′-bifuran-5,5′-dicarboxylate in preparing copolyesters having ultraviolet light (UV) blocking properties.

### BRIEF DESCRIPTION OF THE DRAWINGS

FIG. 1. a) ¹H NMR signal assignments of the polyesters in TFA-d. b) ¹³C NMR assignment of the sequence sensitive butylene group carbon in TFA-d (Fu=furan, Bf=bifuran).

FIG. 2. Heating and cooling at 10° C./min rate shows that both poly(butylene furanoate) (PBF) and poly(ethylene bifuranoate) (PBBf) are typical semi-crystalline materials with pronounced cold-crystallization and melting peaks. See a) 1^{st} heating at 10° C./min. b) 1^{st} cooling at −10° C./min. c) 2^{nd} heating at 10° C./min. d) 1^{st} cooling at −5° C./min (copolyesters). e) 2^{nd} heating at 5° C./min (copolyesters).

FIG. 3. Thermogravimetric decomposition curves for PBF, PBBf, and their random copolyesters in N₂ (heating rate 10° C./min).

FIG. 4. Transmittance of melt-pressed PBF, PBBf, PBF₉₀Bf₁₀, and PBF₂₅Bf₇₅ films.

### DETAILED DESCRIPTION OF EMBODIMENTS

The term “polyester” as used herein is inclusive of polymers prepared from multiple monomers that are referred to herein as copolyesters. Terms such as “polymer” and “polyester” are used herein in a broad sense to refer to materials characterized by repeating moieties or units. The polyesters as described herein may have desirable physical and thermal properties and can be used to partially or wholly replace polyesters derived from fossil resources, such as poly(ethylene terephthalate), PET.

In the context of the present specification, ester monomers preferably comprise the general formula R′OOCRCOOR″, where R may be an alkyl group, or an aryl group, and R′ and R″ may be an alkyl group or an aryl group. Dashed lines in the structure formulas presented herein represent the linkage between a C atom and an 0 atom or between a C atom and another C atom (such as linkages selected from the group consisting of C—R, R—C, R′—O and —O—R″ in the formula R′OOCRCOOR″).

In various aspects described herein, polyesters can be prepared from biomass by utilizing monomers which are obtained from biomass. Furfural and hydroxymethylfurfural (HMF) may be obtained from pentoses and hexoses, respectively. HMF can also be oxidized or reduced to obtain 2,5-furandicarboxylic acid (FDCA). The preparation of dimethyl 2,5-furandicarboxylate and dimethyl 2,2′-bifuran-5,5′-dicarboxylate are described in the Experimental Section below.

In general, polyesters are prepared by reacting a dicarboxylic monomer containing furan and/or other aromatic functionality, and at least one diol. Suitable diols include aliphatic or cycloaliphatic C₃-C₁₀ diols, non-limiting examples of which include 1,3-propanediol, 1,4-butanediol, and 1,2-ethanediol.

Unless otherwise clear from context, percentages referred to herein are expressed as percent by weight based on the total composition weight.

The present invention is directed to a copolyester comprising repeating units of (i) a 2,2′-bifuran-5,5′-dicarboxylic monomer residue, (ii) a diol monomer residue and (iii) an aliphatic or cycloaliphatic C₃-C₈ dicarboxylic monomer residue or an aromatic C₆-C₈ dicarboxylic monomer residue. Preferably, the molar ratio of (i) the 2,2′-bifuran-5,5′-dicarboxylic residues and (iii) the aliphatic or cycloaliphatic C₃-C₈ dicarboxylic residues or the aromatic C₆-C₈ dicarboxylic residues is between 2000:1 and 1:2000 in said copolyester. More preferably, said ratio is 90:10, 75:25, 50:50, 25:75, 10:90, 5:95, 1:100, 1:200, 1:500, 1:1000, 1:2000 or any range between the listed ratios. Most preferably, said range is between 50:50 and 1:2000, between 50:50 and 1:200, between 10:90 and 1:100, 1:200 or 1:2000.

The dicarboxylic monomer residues of the copolyester are preferably derived or obtained from the diesters of said monomers. An example of an diester of the aromatic C₆ dicarboxylic monomer residue is dimethyl 2,5-furandicarboxylate, FDCA (see Experimental Section below). An example of an diester of the aromatic Cs dicarboxylic monomer residue is dimethyl terephthalate (DMT):

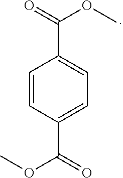

In a preferred embodiment, said 2,2′-bifuran-5,5′-dicarboxylic monomer residue corresponds to or is derived from the compound of Formula

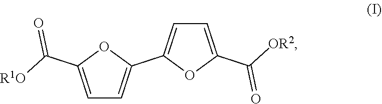

wherein R¹ and R² are each independently selected from the group consisting of: —H, —CH₃, —CH₂CH₃, —(CH₂)₂CH₃, —CH(CH₃)₂, —(CH₂)₃CH₃, —(CH₂)₂OH, —(CH₂)₃OH, —(CH₂)₄OH, —(CH₂)₅OH, —(CH₂)₆OH, —(CH₂)₇OH, —(CH₂)₈OH, and

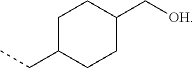

In preferred embodiments, said aliphatic or cycloaliphatic C₃-C₈ dicarboxylic monomer residue or said aromatic C₆-C₈ dicarboxylic monomer residue corresponds to or is derived from the compound of Formula

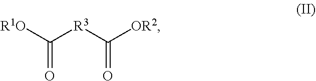

wherein R¹ and R² are each independently as defined above and R³ is selected from the group consisting of —CH₂—, —(CH₂)₂—, —(CH₂)₃—, —(CH₂)₄—, —(CH₂)₅—, and -(CH₂)₆—, and the following cyclic ring structures

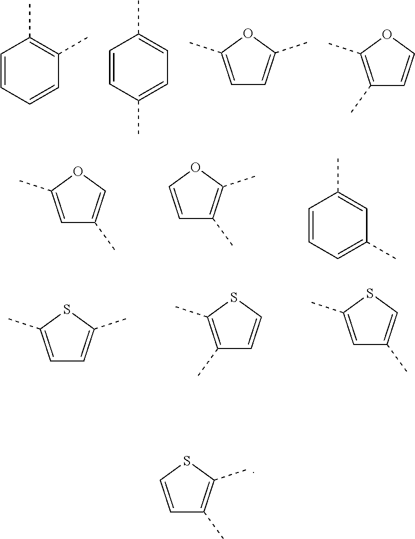

In another preferred embodiment, the present invention is directed to a bifuran copolyester comprising the structure of Formula

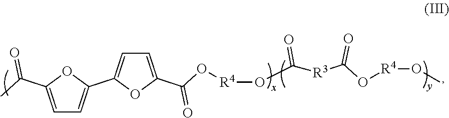

wherein R³ is selected from the group consisting of —CH₂—, —(CH₂)₂—, —(CH₂)₃—, —(CH₂)₄—, —(CH₂)₅—, and —(CH₂)₆—, and the following cyclic ring structures

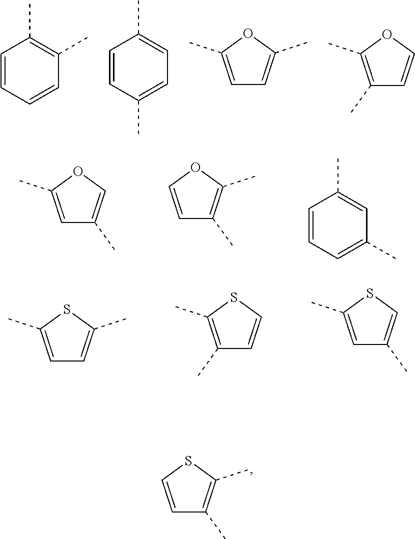

wherein each R⁴ is independently selected from the group consisting of —CH₂—, —(CH₂)₂—, —(CH₂)₃—, —(CH₂)₄—, —(CH₂)₅—, —(CH₂)₆—, —(CH₂)₇—, —(CH₂)₈—, and

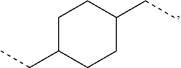

wherein the two structures in parenthesis represent randomly repeating units or residues of the copolyester, and wherein x is independently an integer of 1 or more, preferably 1-30, and y is independently an integer of 1 or more, preferably 1-30. Preferably, the ratio of x:y is between 2000:1 and 1:2000. More preferably, said ratio is 90:10, 75:25, 50:50, 25:75, 10:90, 5:95, 1:100, 1:200, 1:500, 1:1000, 1:2000 or any range between the listed ratios. Most preferably, said range is between 50:50 and 1:2000, between 50:50 and 1:200, between 10:90 and 1:100, 1:200 or 1:2000.

In a more preferred embodiment, R³ is selected from the group consisting of:

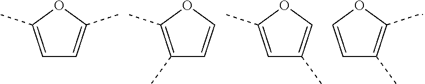

In another more preferred embodiment, R³ is

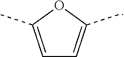

In another preferred embodiment, R³ is selected from the group consisting of:

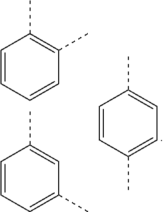

In a more preferred embodiment, R³ is

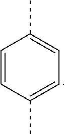

In another preferred embodiment, R³ is selected from the group consisting of:

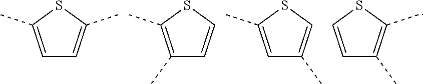

In another preferred embodiment, each R⁴ is —(CH₂)₄—.

In another preferred embodiment, said copolyester comprises the structure

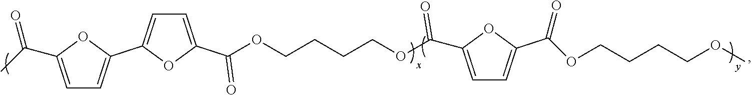

wherein x is independently an integer of 1 or more and y is independently an integer of 1 or more, and wherein the ratio of x:y is preferably between 2000:1 and 1:2000.

Having similar or better properties compared to PET (see Experimental Section below), a person skilled in the art would understand that the above described copolyester can be applied to beverage bottles, food package films, shopping bags and other food package containers.

The present invention is thus also directed to an article or packaging material comprising the bifuran copolyester as defined above. Preferably, said article is a food package or a beverage container.

The present invention is also directed to a film or coating comprising or consisting of the bifuran copolyester as defined above.

The present invention is further directed to a method of preparing a bifuran copolyester, the method comprising the steps of:

a) combining at least (i) a bifuran of Formula

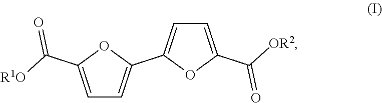

wherein R¹ and R² are each independently selected from the group consisting of: —H, —CH₃, —CH₂CH₃, —(CH₂)₂CH₃, —CH(CH₃)₂, —(CH₂)₃CH₃, —(CH₂)₂OH, —(CH₂)₃OH, —(CH₂)₄OH, —(CH₂)₅OH, —(CH₂)₆OH, —(CH₂)₇OH, —(CH₂)₈OH, and

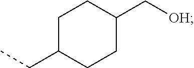

(ii) a diester of an aliphatic or cycloaliphatic C₃-C₈ dicarboxylic monomer residue or of an aromatic C₆-C₈ dicarboxylic monomer residue, preferably a diester compound of Formula

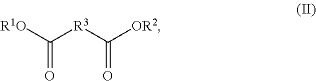

wherein R¹ and R² are each independently as defined above for Formula (I) and R³ is selected from the group consisting of —CH₂—, —(CH₂)₂—, —(CH₂)₃—, —(CH₂)₄—, —(CH₂)₅—, and —(CH₂)₆—, and the following cyclic ring structures

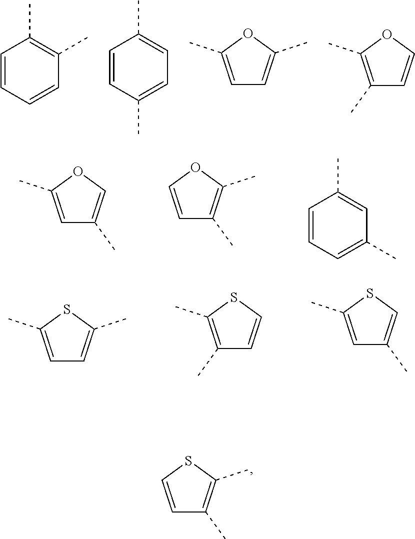

(iii) an aliphatic or cycloaliphatic C₁-C₈ diol, preferably 1,3-propanediol, 1,4-butanediol or 1,2-ethanediol, and (iv) a metal catalyst to form a reaction mixture;

b) subjecting the mixture combined in step a) to a temperature in the range of from about 140° C. to about 220° C. under an inert atmosphere, such as nitrogen or argon atmosphere; and

c) performing polycondensation to the mixture obtained in step b) by heating under reduced pressure to a temperature in the range of from about 210° C. to about 260° C.

A typically useful procedure is thus a conventional two-step melt-polymerization method, such as generally also used in the production of PET. Thereby a mixture of the diol and dicarboxylic monomers are subjected to heating, in two stages. Thus, e.g., the mixture is first exposed to a temperature in the range of 140° C. — 220° C., and thereafter to a temperature of 210° C. — 260° C. Vacuum may be applied gradually, to obtain high molecular weight polyesters. Typically, the pressure applied during step c) is subatmospheric, for example 0.1 to 900 mBar, for example about 1 to 100 mBar.

In a preferred embodiment, said metal catalyst in step a) comprises at least one titanium, bismuth, zirconium, tin, antimony, germanium, aluminium, cobalt, magnesium, or manganese compound. More preferably said metal catalyst is tetrabutyl titanate (titanium (IV) butoxide).

Accordingly, in embodiments of the invention, at least one metal catalyst is present in steps a) and b). The amount of metal in the metal catalyst is in the range of from 20 parts per million (ppm) to 400 ppm by weight, based on a theoretical yield of 100% of the polymer produced. In one embodiment, the metal catalyst is present in the mixture in a concentration in the range of from about 20 ppm to about 300 ppm, based on the total weight of the polymer. Suitable metal catalysts can include, for example, titanium compounds, bismuth compounds such as bismuth oxide, germanium compounds such as germanium dioxide, zirconium compounds such as tetraalkyl zirconates, tin compounds such as butyl stannoic acid, tin oxides and alkyl tins, antimony compounds such as antimony trioxide and antimony triacetate, aluminum compounds such as aluminum carboxylates and alkoxides, inorganic acid salts of aluminum, cobalt compounds such as cobalt acetate, manganese compounds such as manganese acetate, or a combination thereof. Alternatively, the catalyst can be a tetraalkyl titanate Ti(OR)₄, for example tetraisopropyl titanate, tetrabutyl titanate (tetra-n-butyl titanate), tetrakis(2-ethylhexyl) titanate, titanium chelates such as, acetylacetonate titanate, ethyl acetoacetate titanate, triethanolamine titanate, lactic acid titanate, or a combination thereof. In one embodiment, the metal catalyst comprises at least one titanium, bismuth, zirconium, tin, antimony, germanium, aluminum, cobalt, magnesium, or manganese compound. In one embodiment, the metal catalyst comprises at least one titanium compound. Suitable metal catalysts can be obtained commercially or prepared by known methods.

In preferred embodiments, said bifuran of Formula (I) in step a) is dimethyl 2,2′-bifuran-5,5′-dicarboxylate having the structure

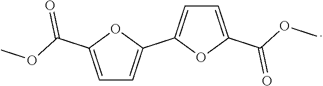

In other preferred embodiments, said diester compound in step a) is dimethyl 2,5-furandicarboxylate having the structure

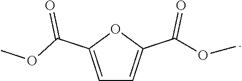

In other preferred embodiments, said aliphatic C₁-C₈ diol is 1,4-butanediol having the structure

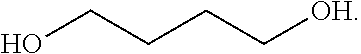

In particularly preferred embodiments, the molar ratio of compounds (i) and (ii) in step a) is between 2000:1 and 1:2000. More preferably, said ratio is 90:10, 75:25, 50:50, 25:75, 10:90, 5:95, 1:100, 1:200, 1:500, 1:1000, 1:2000 or any range between the listed ratios. Most preferably, said range is between 50:50 and 1:2000, between 50:50 and 1:200, between 10:90 and 1:100, 1:200 or 1:2000.

In one embodiment, in step b) of the process a mixture comprising a bifuran of Formula (I), a diester compound of Formula (II), a diol selected from the group consisting of ethylene glycol, 1,3-propanediol, 1,4-butanediol, 1,4-cyclohexanedimethanol, or mixtures thereof, and a metal catalyst is contacted at a temperature in the range of from 140° C. to 220° C. to form a prepolymer.

In the methods disclosed herein, the step b) is preferably performed at a temperature in the range of from 140° C. to 220° C., for example in the range of from 150° C. to 215° C. or from 170° C. to 215° C. or from 180° C. to 210° C. or from 190° C. to 210° C. The time is typically from one hour to several hours, for example 2, 3, 4, or 5 hours or any time in between 1 hour and 5 hours.

In the preferred methods disclosed herein, polycondensation in step c) is performed by heating the prepolymer obtained in step b) under reduced pressure to a temperature in the range of from 210° C. to 260° C. to form the bifuran copolyester. A different catalyst, or more of the same catalyst as used in step b), can be added in step c). The temperature in step c) is typically in the range of from 220° C. to 260° C., for example from 225° C. to 255° C. or from 230° C. to 250° C. The pressure can be from less than about one atmosphere to 0.0001 atmospheres. In this step, the prepolymer undergoes polycondensation reactions, increasing the molecular weight of the polymer, and the diol is distilled off. The polycondensation step can be continued at a temperature in the range of from 210° C. to 260° C. for such a time as the intrinsic viscosity of the polymer reaches at least about 0.60 dL/g. The time is typically from 1 hour to several hours, for example 2, 3, 4, 5, 6, 7, 8, 9 or 10 hours or any time in between 1 hour and 10 hours. In one embodiment, the polymer obtained from step c) has an intrinsic viscosity of at least 0.60 dL/g. Once the desired intrinsic viscosity of the polymer is reached, the reactor and its contents can be cooled, for example to room temperature, to obtain the bifuran copolyester.

The present invention is also directed to use of a 2,2′-bifuran-5,5′-dicarboxylic monomer in preparing copolyesters having ultraviolet light (UV) blocking properties. Preferably, said 2,2′-bifuran-5,5′-dicarboxylic monomer is a diester of the 2,2′-bifuran-5,5′-dicarboxylic monomer, such as dimethyl 2,2′-bifuran-5,5′-dicarboxylate. Preferably, the prepared copolyester contains 0.5-6% of 2,2′-bifuran-5,5′-dicarboxylic monomer residues.

It will be obvious to a person skilled in the art that, as the technology advances, the inventive concept can be implemented in various ways. The invention and its embodiments are not limited to the examples described above but may vary within the scope of the claims.

### EXPERIMENTAL SECTION

Materials and Methods

Commercial grade solvents and reagents were used as received unless otherwise noted.

Dimethyl 2,5-furandicarboxylate, FDCA (1): 2,5-Furandicarboxylic acid (4.00 g) was mixed with dry methanol (120 mL), and 98% sulfuric acid (2 equiv) was added into the mixture.

After refluxing overnight, the cooled mixture was evaporated to about ½ volume. After dilution with deionized water, the precipitated diester was filtered onto paper. After drying in air, the raw product was dissolved in ethyl acetate and filtered through silica gel. After evaporation, dimethyl 2,5-furandicarboxylate was afforded (4.25 g, 93%). ¹H NMR (400 MHz, CDCl₃, ppm): δ 7.23 (s, 2H), 3.94 (s, 6H).

Dimethyl 2,2′-bifuran-5,5′-dicarboxylate, BFDCA (2): The synthesis method reported previously was followed to afford dimethyl 2,2′-bifuran-5,5′-dicarboxylate (4.53 g, 91%) as small white needles (Kainulainen et al., 2018). ¹H NMR (400 MHz, CDCl₃, ppm): 6 7.26 (d, 2H, J=3.7 Hz), 6.90 (d, 2H, J=3.7 Hz), 3.93 (s, 6H).

Polyester synthesis: The polyesters were synthesized by weighing the diester(s) 1 and 2 in an appropriate ratio into a round-bottom flask equipped with a magnetic stirring bar. Dry 1,4-butanediol was added, together with tetrabutyl titanate (0.1 mol % relative to the total diester amount). The flask was heated to 180° C. under argon to initiate the reaction. After 3 h reaction, the pressure was gradually lowered to 2 mbar over the period of 1 h. After increasing the temperature to 250° C., the reaction was allowed to continue for 1 h. The cooled, solid polyester was allowed to dissolve in a mixture of CF₃COOH and CHCl₃. The polyester was precipitated into methanol, affording a fibrous solid. The polyester was dried under vacuum at 60° C. For NMR measurements, a polyester sample was dissolved in CF₃COOD.

Dilute solution viscometry: Intrinsic viscosities were evaluated using flow-times measured with a micro-Ubbelohde viscometer 30.0° C. Polyester samples were dissolved in CF₃COOH, and the solution filtered to prepare 0.5 g/dL solutions for measurements.

Differential scanning calorimetry (DSC): Differential scanning calorimeter (Mettler Toledo DSC 821e) with heating and cooling rates of 10° C./min and nitrogen gas flow of 60 cm³/min was used. 5 mg samples placed in sealed 40 μL A1 pans were used for the measurements.

Thermogravimetric analysis: Thermogravimetric analyzer (Mettler-Toledo TGA851e) with nitrogen flow of 95 cm³/min was run from 30 to 700° C. at a heating rate of 10° C./min.

Melt pressing: Dry polyester was melted at the appropriate temperature inside a closed heat-press, and the melt was then pressed into a film between two polyimide-coated aluminium plates. After cooling, a transparent film was obtained.

Tensile testing: Rectangular tensile test specimens were cut from the films, and the specimens were allowed to stand for 1-2 weeks prior to the tensile tests conducted at 23° C. Tensile tester (Instron 5544, USA) with a gage length of 30 mm and crosshead speed of 5 mm/min was used to characterize the tensile modulus, tensile strength and elongation at break.

UV-Vis: Spectrophotometer (Shimadzu UV-1800) was used to characterize the absorption and transmittance of the melt-pressed films.

Results and Discussion

Dimethyl esters of FDCA (1), BFDCA (2) and 1,4-butanediol were polymerized in accordance with Table 1.

TABLE 1
Synthesis of copolyesters

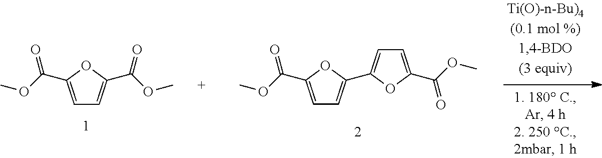

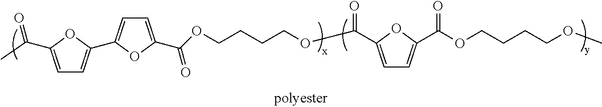

| | Unit ratio, 1:2 (mol %) | | Yield | IV^{b} | Number-average sequence lengths^{c} | | |
|---|---|---|---|---|---|---|---|
| Polyester | Feed | Product^{a} | (%) | (dL/g) | L_{FF} | L_{BB} | Rᵢ^{c} |
| PBF | 100:0 | 100:0 | 93 | 0.77 | — | 0 | 0 |
| PBF₉₀Bf₁₀ | 90:10 | 90:10 | 93 | 0.95 | 8.84 | 1.16 | 0.98 |
| PBF₇₅Bf₂₅ | 75:25 | 76:24 | 95 | 0.90 | 3.65 | 1.38 | 1.00 |
| PBF₅₀Bf₅₀ | 50:50 | 51:49 | 98 | 0.87 | 2.08 | 1.89 | 1.01 |
| PBF₂₅Bf₇₅ | 25:75 | 26:74 | 90 | 0.67 | 1.27 | 4.13 | 1.03 |
| PBF₁₀Bf₉₀ | 10:90 | 10:90 | 91 | 0.70 | 1.12 | 6.94 | 1.04 |
| PBBf | 0:100 | 0:100 | 97 | 0.72 | 0 | — | 0 |

^{a}Calculated from ¹H NMR integrals in CF₃COOD.
^{b}Intrinsic viscosity according to the Billmeyer relationⁱ.
^{c}Via ¹³C NMR using Equations 1 and 2, randomness index Rᵢ calculated from Equation 3.
ⁱBillmeyer, F. Methods for estimating intrinsic viscosity. J. Polym. Sci., 1949, 4, 83-86.

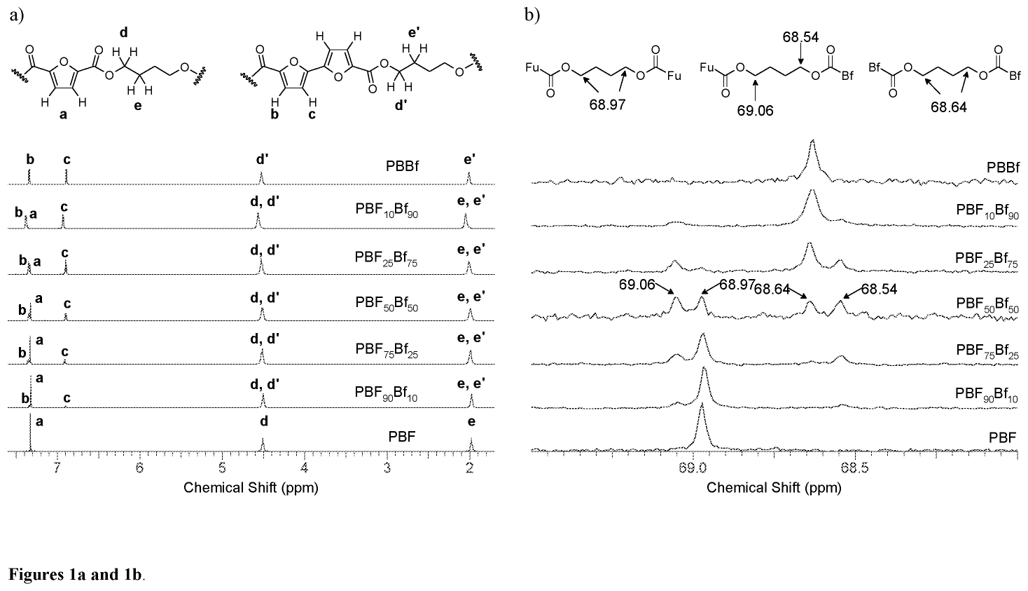

Using the appropriate feed ratio of 1 and 2, the desired polyesters were prepared in the presence of catalytic tetrabutyl titanate (TBT). The purity and structure of the polyesters were confirmed with ¹H NMR analysis (FIG. 1). Diester feed ratios were practically identical to the ratios observed in the actual products. This suggests that both 1 and 2 are suitably stable and reactive monomers in polycondensation reactions.

¹H and ¹³C NMR analysis also confirms the random distribution of furan and bifuran units in the polyester chains. Specifically, assignment of the chain structure was obtained (FIG. 1b, Table 1) from Equations 1 and 2 by using areas under the corresponding peaks (A_{FF}, A_{BB}, A_{FB}, and A_{BF}) in the ¹³C NMR spectrum. Calculating the randomness indices (Rᵢ, Equation 3) using the values from Equations 1 and 2, a highly random distribution of both furan-based moieties can be discerned.

$${L}_{FF} = \frac{{A}_{FF} + 1 / 2 ( {A}_{FB} + {A}_{BF} )}{1 / 2 ( {A}_{F B} + {A}_{BF} )} \qquad ( 1 )$$

$${L}_{BB} = \frac{{A}_{BB} + 1 / 2 ( {A}_{FB} + {A}_{BF} )}{1 / 2 ( {A}_{F B} + {A}_{BF} )} \qquad ( 2 )$$

$${R}_{i} = \frac{1}{{L}_{FF}} + \frac{1}{{L}_{BB}} \qquad ( 3 )$$

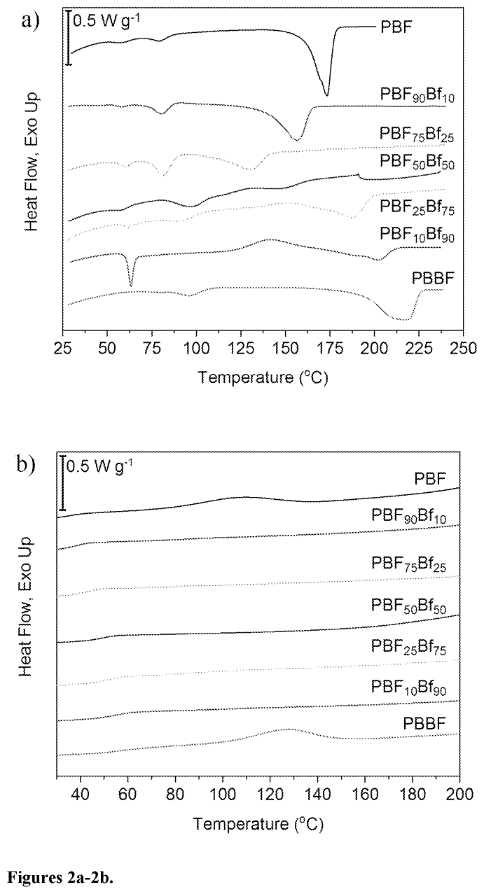

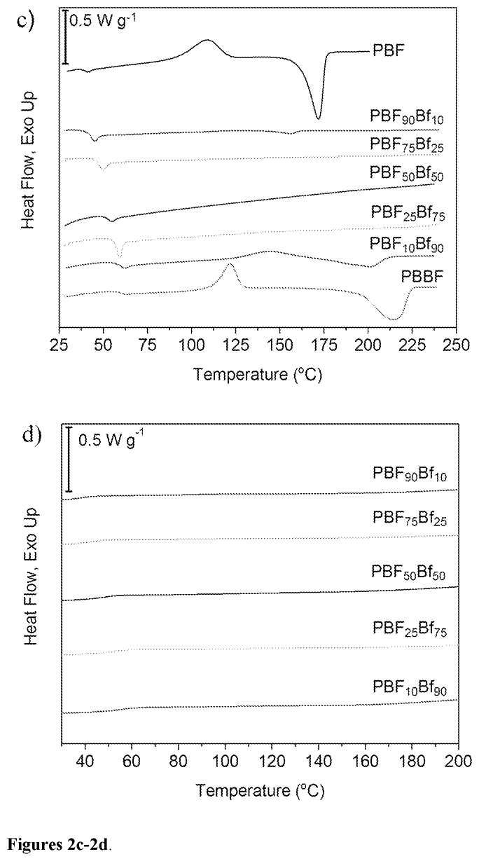

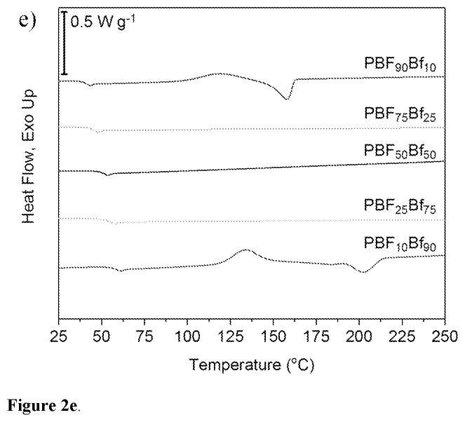

The thermal properties were characterized using DSC. Slow 10° C./min scanning rate reveals that PBF and PBBf are typical semi-crystalline materials, having clear cold-crystallization and melting peaks (FIGS. 2a-c). The thermal properties of both PBF and PBBf correspond to previously reported values, though T_{g} was not previously reported for PBBf (Miyagawa et al., 2018). At even slower scanning rate (5° C./min), the semi-crystalline nature of PBF₉₀Bf₁₀ and PBF₉₀Bf₁₀ becomes evident (FIG. 2e). The data point to the fact that higher comonomer incorporation hinders crystallization. When the comonomer content approaches equimolar ratio, e.g. in PBF₇₅Bf₂₅, PBF₅₀Bf₅₀, and PBF₂₅Bf₇₅, highly amorphous copolyesters are obtained. The impact on crystallinity is lessened if the content of defects resulting from the incorporation of the minor comonomer is kept relatively small, e.g. below 10 mol %. However, high bifuran content increases the stiffness of the polyester chains, resulting in higher T_{g}.

TABLE 3
Thermal properties of the copolyesters

| | | Tₘ (° C.) | | | | |
|---|---|---|---|---|---|---|
| | T_{g} | 1^{st} | | | T_{d5} | T_{d} |
| Sample | (° C.) | heating | 2^{nd} heating | T_{cc} (° C.) | (° C.) | (° C.) |
| PBF | 39 | 173 | 172 | 109 | 366 | 391 |
| PBF₉₀Bf₁₀ | 43 | 81, 157 | 156 (158*) | nd (119*) | 365 | 391 |
| PBF₇₅Bf₂₅ | 49 | 82, 130 | nd | nd | 364 | 392 |
| PBF₅₀Bf₅₀ | 53 | 97, 145 | nd | nd | 365 | 393 |
| PBF₂₅Bf₇₅ | 58 | 89, 188 | nd | nd | 367 | 398 |
| PBF₁₀Bf₉₀ | 60 | 202 | 202 (184*, 202*) | 144 (134*) | 364 | 397 |
| PBBf | 62 | 217 | 215 | 122 | 370 | 402 |

T_{g}: Glass transition temperature (2^{nd} heating) at 10° C./min.
Tₘ: Melting point from heating at 10° C./min (*5° C./min)
T_{cc}: Peak of cold-crystallization (2^{nd} heating) at 10° C./min (*5° C./min).
T_{d5}: Temperature at 5% sample mass-loss.
T_{d}: Temperature at peak mass-loss rate.
nd: not detected.

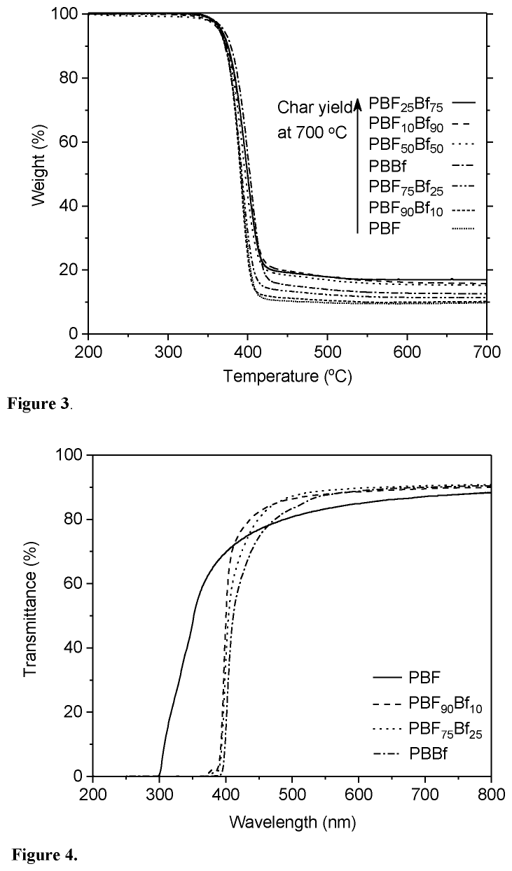

Thermogravimetric analysis shows that the thermal stabilities (Table 4 and FIG. 3) are comparable to existing polyester-type materials, i.e. each composition underwent a single decomposition step at 391-402° C. These values are highly comparable to PET and PBT, and especially PEF. However, the more highly aromatic bifuran structure leads to an increase in the char yield. In conclusion, it should be recognized that the gap between decomposition and processing temperatures is wide for these materials.

All copolyesters had excellent mechanical properties, most notably exceeding the performance of PBF, with tensile strengths of ≥65 MPa. The tensile moduli were practically unchanged across the series.

TABLE 4
Mechanical properties of the copolyesters

| Sample^{a} | Eₜ (GPa) | σₘ (MPa) | ε_{b} (%) |
|---|---|---|---|
| PBF | 2.00 ± 0.09 | 58.9 ± 2.2 | 4.00 ± 0.25 |
| PBF₉₀Bf₁₀ | 2.08 ± 0.02 | 65.1 ± 2.5 | 4.17 ± 0.22 |
| PBF₇₅Bf₂₅ | 1.99 ± 0.08 | 66.6 ± 3.1 | 4.97 ± 0.24 |
| PBF₅₀Bf₅₀ | 2.15 ± 0.10 | 66.0 ± 1.3 | 4.26 ± 0.37 |
| PBF₂₅Bf₇₅ | 1.97 ± 0.12 | 65.8 ± 4.2 | 4.99 ± 0.22 |
| PBF₁₀Bf₉₀ | 2.07 ± 0.04 | 65.5 ± 2.7 | 5.01 ± 0.37 |
| PBBf | 2.03 ± 0.06 | 66.0 ± 3.0 | 5.39 ± 0.21 |

^{a}Five amorphous specimens were evaluated for each composition.
Eₜ = Tensile modulus.
σₘ = maximum tensile stress.
ε_{b} = elongation at break.

The most notable effect provided by the bifuran moieties is their inherent UV absorbance. The copolyesters functioned as effective UV light filters up to 400 nm wavelengths (FIG. 4), irrespective of the bifuran content at the prepared thickness (0.10-0.15 mm). It is particularly notable that PBF does not provide similar UV light absorption at 300-400 nm. Thus, the copolyester films are promising transparent bio-based materials with low UV transmittance, as the visible light transmittance was excellent (e.g. 80% at 450 nm). While it is known (Kainulainen et al., 2018, and Miyagawa et al., 2018), that monomer 2 has its absorption maximum at longer wavelength (325 nm) than monomer 1 (265 nm) in solution, the bifuran moieties can provide surprisingly significant UV absorbance up to almost 400 nm. In contrast, PBF decreases in absorbance rapidly at wavelengths longer than 300 nm.

### Conclusions

PBF and PBBf are bio-based semi-crystalline polyesters, while their random copolyesters become more amorphous when more of the minor comonomer is incorporated. The copolyesters were characterized by good mechanical strengths and glass-transition temperatures of 42-60° C. Incorporating more of the minor comonomer, a degree of control over the crystallization can be achieved. Most notably, incorporating a low level of the minor comonomer allows tailored properties. In particular, surprisingly low bifuran content provides a copolyester with very low UV transmittance, lower melting point and higher glass-transition temperature, depending on the exact monomer ratio. Very high bifuran content allows the preparation of materials with higher glass-transition temperature.

### REFERENCES

Billmeyer, F. Methods for estimating intrinsic viscosity. J. Polym. Sci., 1949, 4, 83-86.

Kainulainen, T. P., Sirviö, J. A., Sethi, J., Hukka, T. I., Heiskanen, J. P. UV-Blocking Synthetic Biopolymer from Biomass-Based Bifuran Diester and Ethylene Glycol., Macromolecules, 2018, 51, 1822-1829.

Miyagawa, N., Suzuki, T., Okano, K., Matsumoto, T., Nishino, T., Mori, A., Synthesis of Furan Dimer-Based Polyamides with a High Melting Point, J. Polym. Sci., Part A: Polym. Chem., 2018, 56, 1516-1519.

1. A bifuran copolyester comprising repeating units of (i) a 2,2′-bifuran-5,5′-dicarboxylic monomer residue, (ii) a diol monomer residue, and (iii) an aliphatic or cycloaliphatic C₃-C₈ dicarboxylic monomer residue or an aromatic C₆-C₈ dicarboxylic monomer residue.

2. The bifuran copolyester according to claim 1, wherein said 2,2′-bifuran-5,5′-dicarboxylic monomer residue is derived from a compound of Formula (I): 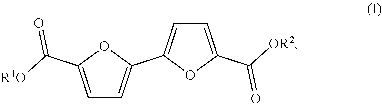
wherein R¹ and R² are each independently selected from the group consisting of: —H, —CH₃, —CH₂CH₃, —(CH₂)₂CH₃, —CH(CH₃)₂, —(CH₂)₃CH₃, —(CH₂)₂OH, —(CH₂)₃OH, —(CH₂)₄OH, —(CH₂)₅OH, —(CH₂)₆OH, —(CH₂)₇OH, —(CH₂)₈OH, and

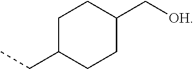

3. The bifuran copolyester according to claim 1, wherein said aliphatic or cycloaliphatic C₃-C₈ dicarboxylic monomer residue or said aromatic C₆-C₈ dicarboxylic monomer residue is derived from a compound of Formula (II): 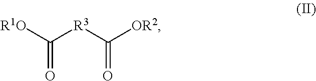
wherein R¹ and R² are independently as defined in claim 2 for Formula (I) and R³ is selected from the group consisting of —CH₂—, —(CH₂)₂—, —(CH₂)₃—, —(CH₂)₄—, —(CH₂)₅—, —(CH₂)₆—, and the following cyclic ring structures:

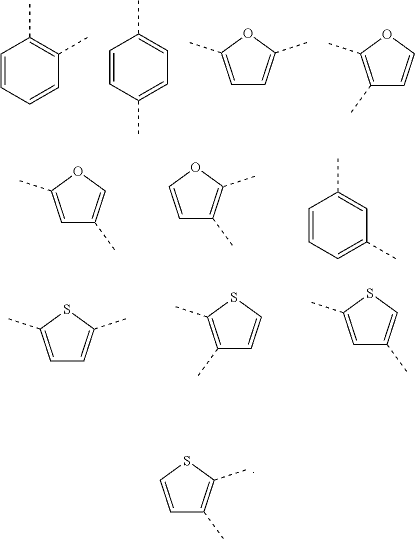

4. The bifuran copolyester according to claim 1, wherein said diol monomer residue is derived from an aliphatic, cycloaliphatic or aromatic C₁-C₈ diol.

5. The bifuran copolyester according to claim 4, wherein said aliphatic, cycloaliphatic or aromatic C₁-C₈ diol is selected from the group consisting of: ethylene glycol, 1,3-propanediol, 1,4-butanediol, and 1,4-cyclohexanedimethanol.

6. The bifuran copolyester according to claim 1, wherein a mixture of the 2,2′-bifuran-5,5′-dicarboxylic residue and the aliphatic or cycloaliphatic C₃-C₈ dicarboxylic residue or the aromatic C₆-C₈ dicarboxylic residue in said copolyester comprises a molar ratio of the 2,2′-bifuran-5,5′-dicarboxylic residue to the aliphatic or cycloaliphatic C₃-C₈ dicarboxylic residue or the aromatic C₆-C₈ dicarboxylic residue in a range of from 2000:1 to 1:2000.

7. The bifuran copolyester according to claim 1, wheren said aromatic C₆-C₈ dicarboxylic monomer residue is derived from dimethyl terephthalate (DMT).

8. The bifuran copolyester according to claim 1, wherein the copolyester comprises the structure of Formula (III): 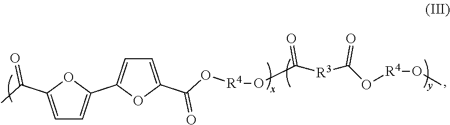
wherein R³ is selected from the group consisting of —CH₂—, —(CH₂)₂—, —(CH₂)₃—, —(CH₂)₄—, —(CH₂)₅—, —(CH₂)₆—, and the following cyclic ring structures: 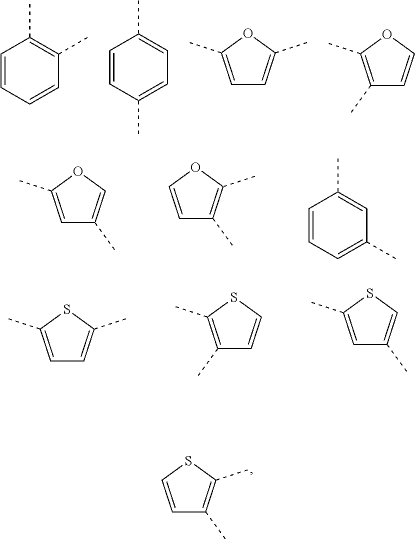
and wherein each R⁴ is independently selected from the group consisting of —CH₂—, —(CH₂)₂—, —(CH₂)₃—, —(CH₂)₄—, —(CH₂)₅—, —(CH₂)₆—, —(CH₂)₇—, —(CH₂)₈- and 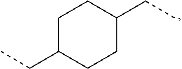
and
wherein the two structures in parenthesis parentheses represent randomly repeating units of the copolyester, and wherein x is independently an integer of 1 or more and y is independently an integer of 1 or more.

9. The bifuran copolyester according to claim 8, wherein R³ is selected from the group consisting of:

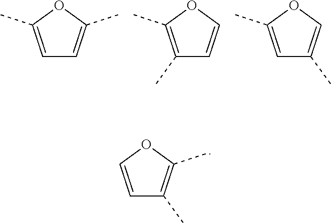

10. The bifuran copolyester according to claim 9, wherein R³ is

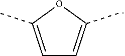

11. The bifuran copolyester according to claim 8, wherein R³ is selected from the group consisting of:

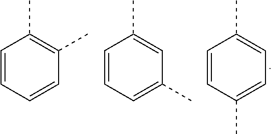

12. The bifuran copolyester according to claim 11, wherein R³ is

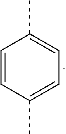

13. The bifuran copolyester according to claim 8, wherein R³ is selected from the group consisting of:

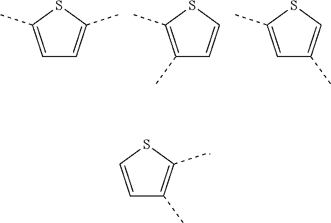

14. The bifuran copolyester according to claim 8, wherein each R⁴ is —(CH₂)₄—.

15. The bifuran copolyester according to claim 8, wherein the ratio of x:y is between 2000:1 and 1:2000.

16. The bifuran copolyester according to claim 15, wherein said ratio is 90:10, 75:25, 50:50, 25:75 or 10:90.

17. The bifuran copolyester according to claim 15, wherein said ratio is between 50:50 and 1:2000.

18. The bifuran copolyester according to claim 8, wherein said copolyester comprises the structure: 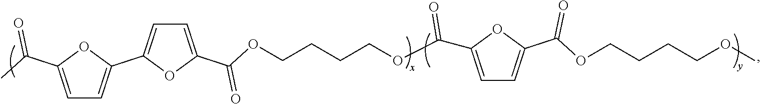
wherein x is independently an integer of 1 or more and y is independently an integer of 1 or more, and wherein the ratio of x:y is between 2000:1 and 1:2000.

19. An article, packaging material, or coating comprising the bifuran copolyester according to claim 1.

20. The article, packaging material, or coating according to claim 19, wherein said article is a food package or a beverage container.

21. (canceled)

22. A method of preparing a bifuran copolyester, the method comprising the steps of:
a) combining at least (i) a bifuran of Formula (I): 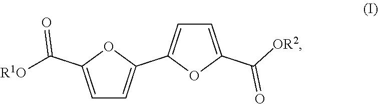
wherein R¹ and R² are each independently selected from the group consisting of: —H, —CH₃, —CH₂CH₃, —(CH₂)₂CH₃, —CH(CH₃)₂, —(CH₂)₃CH₃, —(CH₂)₂OH, —(CH₂)₃OH, —(CH₂)₄OH, —(CH₂)₅OH, —(CH₂)₆OH, —(CH₂)₇OH, —(CH₂)₈OH, and 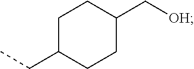
(ii) a diester of an aliphatic or cycloaliphatic C₃-C₈ dicarboxylic monomer residue or of an aromatic C₆-C₈ dicarboxylic monomer residue, preferably a diester compound of Formula 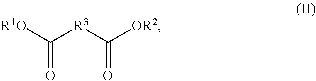
wherein R¹ and R² are each as defined above for Formula (I) and R³ is selected from the group consisting of —CH₂—, —(CH₂)₂—, —(CH₂)₃—, —(CH₂)₄—, —(CH₂)₅—, —(CH₂)₆—, and the following cyclic ring structures 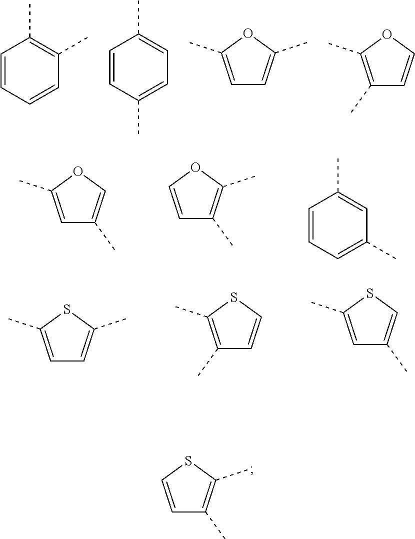
and
(iii) an aliphatic, cycloaliphatic or aromatic C₁-C₈ diol and (iv) a metal catalyst to form a reaction mixture;
b) subjecting the mixture combined in step a) to a temperature in the range of from about 140° C. to about 220° C. under an inert atmosphere;
c) performing polycondensation to the mixture obtained in step b) by heating under reduced pressure to a temperature in the range of from about 210° C. to about 260° C.

23. The method according to claim 22, wherein said diol is 1,3-propanediol, 1,4-butanediol or 1,2-ethanediol.

24. The method according to claim 22, wherein the metal catalyst comprises at least a titanium, bismuth, zirconium, tin, antimony, germanium, aluminium, cobalt, magnesium, or manganese compound.

25. The method according to claim 22, wherein said bifuran is dimethyl 2,2′-bifuran-5,5′-dicarboxylate having the structure:

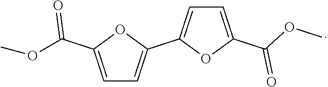

26. The method according to claim 22, wherein said diester compound is dimethyl 2,5-furandicarboxylate having the structure

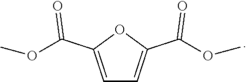

27. The method according to claim 22, wherein said aliphatic C₁-C₈ diol is 1,4-butanediol having the structure

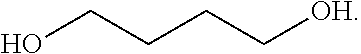

28. The method according to claim 22, wherein said metal catalyst is tetrabutyl titanate.

29. The method according to claim 22, wherein the molar ratio of compounds (i) and (ii) in step a) is between 2000:1 and 1:2000.

30. The method according to claim 29, wherein said ratio is 90:10, 75:25, 50:50, 25:75 or 10:90.

31. The method according to claim 29, wherein said ratio is between 50:50 and 1:2000.

32. (canceled)

33. (canceled)
